(19) United States
(12) Patent Application Publication
(10) Pub. No.: US 2020/0342330 A1
(43) Pub. Date: Oct. 29, 2020

(54) MIXED-BINARY CONSTRAINED OPTIMIZATION ON QUANTUM COMPUTERS

(71) Applicant: International Business Machines Corporation, Armonk, NY (US)

(72) Inventors: Claudio Gambella, Dublin (IE); Andrea Simonetto, Celbridge (IE); Martin Mevissen, Dublin (IE); Jakub Marecek, Dublin (IE)

(21) Appl. No.: 16/395,560

(22) Filed: Apr. 26, 2019

(51) Int. Cl. G06N 5/00; G06N 10/00; G06N 5/04; G06F 7/523

(52) U.S. Cl. CPC G06N 5/003; G06F 7/523; G06N 5/045; G06N 10/00

(57) ABSTRACT

Techniques for mixed-binary constrained optimization facilitated by quantum computers are provided. In one example, a system includes a quantum processor and a classical processor. The quantum processor performs a binary unconstrained optimization process for data associated with a decision-making problem. The classical processor performs a convex constrained optimization process for the data.

### BACKGROUND

The subject disclosure relates to quantum computing and, more specifically, to optimization associated with quantum computing.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus and/or computer program products for facilitating mixed-binary constrained optimization on quantum computers are described.

According to an embodiment, a system can comprise a quantum processor and a classical processor. The quantum processor can perform a binary unconstrained optimization process for data associated with a decision-making problem. The classical processor can perform a convex constrained optimization process for the data.

According to another embodiment, a method is provided. The method can comprise performing, by a quantum processor, a binary unconstrained optimization process for data associated with a decision-making problem. The method can also comprise performing, by a classical processor, a convex constrained optimization process for the data.

According to yet another embodiment, a system can comprise a quantum processor and a classical processor. The quantum processor can perform a binary unconstrained optimization process for data associated with a decision-making problem. The classical processor can perform a convex constrained optimization process for the data. The quantum processor can also generate solution data associated with the decision-making problem based on the binary unconstrained optimization process and the convex constrained optimization process.

### DESCRIPTION OF THE DRAWINGS

FIG. 1 illustrates a block diagram of an example, non-limiting system associated with hybrid optimization computing in accordance with one or more embodiments described herein.

FIG. 2 illustrates a block diagram of another example, non-limiting system associated with hybrid optimization computing in accordance with one or more embodiments described herein.

FIG. 3 illustrates a block diagram of yet another example, non-limiting system associated with hybrid optimization computing in accordance with one or more embodiments described herein.

FIG. 4 illustrates a block diagram of yet another example, non-limiting system associated with hybrid optimization computing in accordance with one or more embodiments described herein.

FIG. 5 illustrates an example, non-limiting formulation in accordance with one or more embodiments described herein.

FIG. 6 illustrates another example, non-limiting formulation in accordance with one or more embodiments described herein.

FIG. 7 illustrates an example, non-limiting system associated with a binary unconstrained optimization process and a convex constrained optimization process in accordance with one or more embodiments described herein.

FIG. 8 illustrates a flow diagram of an example, non-limiting computer-implemented method for facilitating mixed-binary constrained optimization on quantum computers in accordance with one or more embodiments described herein.

FIG. 9 illustrates a block diagram of an example, non-limiting operating environment in which one or more embodiments described herein can be facilitated.

FIG. 10 illustrates a block diagram of an example, non-limiting cloud computing environment in accordance with one or more embodiments of the present invention.

FIG. 11 illustrates a block diagram of example, non-limiting abstraction model layers in accordance with one or more embodiments of the present invention.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

For numerous technologies (e.g., machine learning technologies, optimization technologies, chemistry technologies, etc.) decision-making problems can be computationally complex. However, decision-making problems for technologies are often not practically solvable on classical computers due to, for example, the computational complexity of the decision-making problems. As such, quantum computing can alternatively be employed for decision-making problems for technologies (e.g., machine learning technologies, optimization technologies, chemistry technologies, etc.). Quantum computing employs quantum physics to encode information rather than binary digital techniques based on transistors. For example, a quantum computer can employ quantum bits (e.g., qubits) that operate according to a superposition principle of quantum physics and an entanglement principle of quantum physics. The superposition principle of quantum physics allows each qubit to represent both a value of “1” and a value of “0” at the same time. The entanglement principle of quantum physics states allows qubits in a superposition to be correlated with each other. For instance, a state of a first value (e.g., a value of “1” or a value of “0”) can depend on a state of a second value. As such, a quantum computer can employ qubits to encode information rather than binary digital techniques based on transistors.

In this regard, embodiments described herein include systems, computer-implemented methods, and/or computer program products for facilitating mixed-binary constrained optimization on quantum computers. For instance, mixed-binary constrained optimization (MBCO) problems can be solved on quantum computers. In an example, MBCO problems can be solved on near-term quantum computers. An MBCO problem can be associated with binary variables and/or continuous variables. Additionally or alternatively, an MBCO problem can be associated with equality constraints and/or inequality constraints. In an aspect, a solution for an MBCO problem can be provided. Furthermore, noise associated with a quantum computer can also be minimized while providing a solution for an MBCO problem. In an embodiment, a system for facilitating MBCO can receive, as input data, an MBCO formulation expressing a real-world technological application. Additionally or alternatively, the system for facilitating MBCO can receive, as input data, problem data for a decision-making problem associated with the real-world technological application. The MBCO can be decomposed by the system into a binary unconstrained optimization problem and a convex constrained subproblem. The system can also provide a solution to the MBCO. In an aspect, the system can perform iterative hybrid optimization associated with a quantum processing and a classical processing. For example, a quantum device (e.g., a quantum processor) can perform a binary unconstrained optimization process associated with the binary unconstrained optimization problem for the MBCO problem. Furthermore, a classical processor can perform a convex constrained process associated with the convex constrained subproblem for the MBCO problem. A solution for the MBCO problem can be obtained with a maximum number of iterations associated with the binary unconstrained optimization process and/or the convex constrained process. Additionally or alternatively, solution for the MBCO problem can be obtained by achieving a convergence criterion associated with the binary unconstrained optimization process and/or the convex constrained process. In certain embodiments, mixed-binary linear programming (MBLP) can be employed to facilitate obtaining a solution for the MBCO problem. Additionally or alternatively, in certain embodiments, a non-convex alternating direction of multipliers (ADMM) can be applied to the MBLP. In certain embodiments, an unconstrained binary subproblem for the MBCO problem can be optimized. For example, an unconstrained binary subproblem for the MBCO problem can be optimized upon formulating an Ising Hamiltonian model. Additionally or alternatively, in certain embodiments, a linear continuous constrained subproblem can be optimized via a classical optimization algorithm. Additionally or alternatively, in certain embodiments, the non-convex ADMM can update one or more multipliers for the MBLP. As such, a solution for a decision-making problem can be achieved. A quantum optimization process can also be improved. Moreover, performance and/or efficiency of a quantum processor can be improved. Furthermore, accuracy of data generated by a quantum processor can be improved.

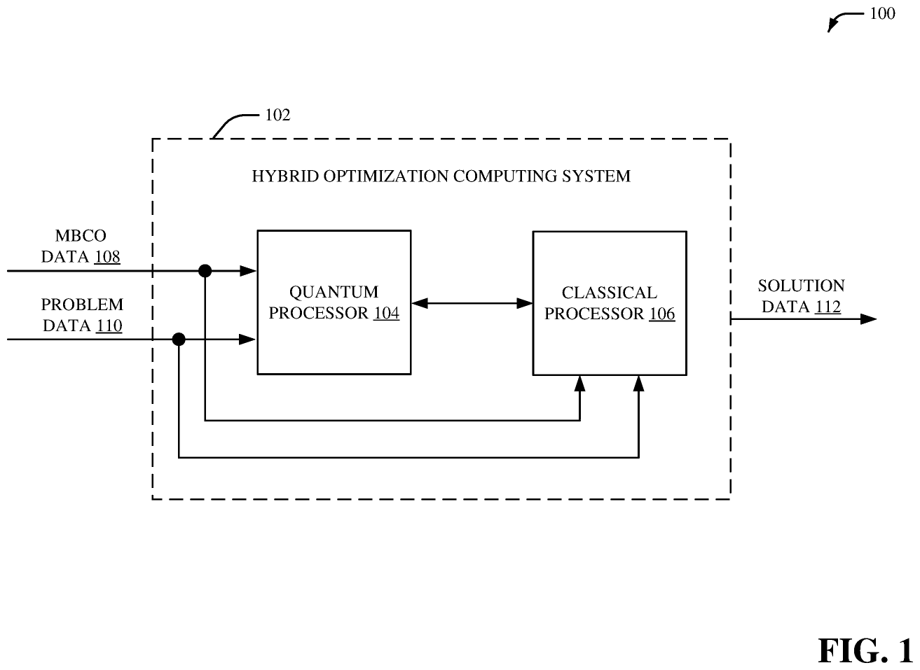

FIG. 1 illustrates a block diagram of an example, non-limiting system 100 for facilitating mixed-binary constrained optimization on quantum computers in accordance with one or more embodiments described herein. In various embodiments, the system 100 can be a quantum computing system associated with technologies such as, but not limited to, quantum computing technologies, quantum computer technologies, quantum circuit technologies, quantum processor technologies, quantum device technologies, artificial intelligence technologies, machine learning technologies, optimization technologies, chemistry technologies, decision-making technologies, real-world application technologies, engineering technologies, mechanics technologies, finance technologies, asset flow allocation technologies, power flow technologies, network technologies, and/or other technologies. The system 100 can employ hardware and/or software to solve problems that are highly technical in nature, that are not abstract and that cannot be performed as a set of mental acts by a human. Further, in certain embodiments, some of the processes performed may be performed by one or more specialized computers (e.g., a quantum computer, one or more specialized processing units, etc.) for carrying out defined tasks related to quantum computing. The system 100 and/or components of the system 100 can be employed to solve new problems that arise through advancements in technologies mentioned above, computer architecture, and/or the like. One or more embodiments of the system 100 can provide technical improvements to quantum computing systems, quantum computer systems, quantum circuit systems, quantum processor systems, quantum device systems, artificial intelligence systems, machine learning systems, optimization systems, chemistry systems, decision-making systems, real-world application systems, engineering systems, mechanics systems, finance systems, asset flow allocation systems, power flow systems, network systems, and/or other systems. One or more embodiments of the system 100 can also provide technical improvements to a quantum device (e.g., a quantum processor, a quantum computer, etc.) by improving processing performance of the quantum device, improving processing efficiency of the quantum device, improving processing characteristics of the quantum device, improving timing characteristics of the quantum device, improving power efficiency of the quantum device, and/or improving accuracy of data generated by the quantum device.

In the embodiment shown in FIG. 1, the system 100 can include a hybrid optimization computing system 102. As shown in FIG. 1, the hybrid optimization computing system 102 can include a quantum processor 104 and a classical processor 106. For instance, the quantum processor 104 and the classical processor 106 can be employed to provide a hybrid quantum computing/classical computing environment. In an aspect, the quantum processor 104 can be employed to perform one or more quantum computations associated with a MBCO data 108 and/or problem data 110. Additionally, the classical processor 106 can be employed to perform one or more classical computations associated with the MBCO data 108 and/or the problem data 110. The quantum processor 104 can be a machine that performs a set of calculations based on principle of quantum physics. For instance, the quantum processor 104 can perform one or more quantum computations associated with a set of quantum gates and/or a set of qubits. Furthermore, the quantum processor 104 can encode information using qubits. In an aspect, the quantum processor 104 can facilitate one or more quantum measurements associated with the MBCO data 108 and/or the problem data 110. The classical processor 106 can be a machine that performs a set of calculations based on bits. For instance, the classical processor 106 can perform one or more classical computations associated with a set of logical gates and/or a set of bits. Furthermore, the classical processor 106 can encode information using bits. In an aspect, the classical processor 106 can execute a set of instruction threads associated with the MBCO data 108 and/or the problem data 110. In an embodiment, aspects of the classical processor 106 can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described. In an aspect, the classical processor 106 can also be associated with a memory that stores computer executable components and instructions. The MBCO data 108 can be mixed-binary constrained optimization data. In an aspect, the MBCO data 108 can be data associated with a decision-making problem. For instance, the MBCO data 108 can be associated with a mixed-binary constrained optimization problem. In an example, the MBCO data 108 can be a mixed-binary constrained optimization formulation that expresses a relationship and/or a structure for a real-world application. The problem data 110 can include one or more variables for the MBCO data 108. For example, the problem data 110 can include one or more vectors of data and/or one or more data matrices that are applied to the MBCO data 108. The problem data 110 can also be, for example, problem data for the mixed-binary constrained optimization problem. In another aspect, the classical processor 106 can be communicatively coupled to the quantum processor 104. In one example, the classical processor 106 can be communicatively coupled to the quantum processor 104 via a wired communication channel. In another example, the classical processor 106 can be communicatively coupled to the quantum processor 104 via a wireless communication channel

In an embodiment, the quantum processor 104 can perform a binary unconstrained optimization process for the MBCO data 108 and/or the problem data 110. The binary unconstrained optimization process can be a process to solve a binary unconstrained optimization problem associated with the MBCO data 108 and/or the problem data 110. In an aspect, the quantum processor 104 can map the binary unconstrained optimization process onto a set of qubits of the quantum processor 104. The binary unconstrained optimization process can process binary variables and/or unconstrained variables. A binary variable can be a variable with either a first value or a second value. An unconstrained variable can be a variable with any value. For example, an unconstrained variable can be a continuous variable with an infinite number of possible values. In another aspect, the binary unconstrained optimization process performed by the quantum processor 104 can be associated with a complexity class. For instance, the complexity class for the binary unconstrained optimization process can be a nondeterministic polynomial-time (NP) complexity class associated with an execution time for the decision-making problem that is bounded by a polynomial expression. In certain embodiments, the quantum processor 104 can perform the binary unconstrained optimization process based on a variational quantum eigensolver. For example, the binary unconstrained optimization process can be mapped to a quantum-variational eigensolver architecture of the quantum processor 104. In an alternate embodiment, the quantum processor 104 can perform the binary unconstrained optimization process based on phase estimation (e.g., a quantum phase estimation algorithm). For instance, the binary unconstrained optimization process can be performed based on a quantum phase estimation algorithm that estimates a phase (e.g., an eigenvalue) of an eigenvector. In an aspect, the quantum processor 104 can determine a mathematical expression represented by a set of eigenvalues and/or a set of eigenvectors based on the quantum phase estimation algorithm. An eigenvector can be a vector that can change by a scalar factor when a linear transformation is applied to the eigenvector. An eigenvalue can be the scalar factor applied to an eigenvector to obtain a linear transformation. In another aspect, the quantum processor 104 can determine quantum measurement data indicative of a set of quantum measurements associated with the set of eigenvalues and/or a set of eigenvectors. However, it is to be appreciated that, in certain embodiments, the quantum processor 104 can additionally or alternatively perform the binary unconstrained optimization process based on one or more other techniques. The classical processor 106 can perform a convex constrained optimization process for the MBCO data 108 and/or the problem data 110. The convex constrained optimization process can be a process to solve a convex constrained optimization subproblem associated with the MBCO data 108 and/or the problem data 110. The convex constrained optimization process can process constrained variables associated with a convex function. A constrained variable can be a variable with a bounded value. In an aspect, the convex constrained optimization process can be employed to minimize cost and/or energy associated with the binary unconstrained optimization process. For instance, the convex constrained optimization process can generate a loss function to modify one or more portions of the binary unconstrained optimization process and/or one or more settings for the quantum processor 104. In certain embodiments, the quantum processor 104 and/or the classical processor 106 can employ an alternating direction method of multipliers (ADMM) process to split the MBCO data 108 and/or the problem data 110 for processing by the binary unconstrained optimization process and the convex constrained optimization process. For example, the quantum processor 104 and/or the classical processor 106 can employ an ADMM process to split the decision-making problem for processing by the binary unconstrained optimization process and the convex constrained optimization process. In certain embodiments, the quantum processor 104 can provide quantum measurement data associated with the binary unconstrained optimization process to facilitate the convex constrained optimization process. In certain embodiments, the classical processor 106 can provide optimization data associated with the convex constrained optimization process to the quantum processor 104 to facilitate the binary unconstrained optimization process.

In certain embodiments, the quantum processor 104 can repeat one or more iterations of the binary unconstrained optimization process in parallel to execution of the convex constrained optimization process by the classical processor 106. In certain embodiments, the classical processor 106 can provide first output data associated with the convex constrained optimization process to the quantum processor 104. The quantum processor 104 can update and/or modify the binary unconstrained optimization process based on the first output data associated with the convex constrained optimization process. Additionally or alternatively, the quantum processor 104 can generate solution data 112 based on the first output data and/or second output data generated by the binary unconstrained optimization process. The solution data 112 can be indicative of solution information for the decision-making problem. For example, the solution data 112 can be indicative of solution information for the mixed-binary constrained optimization problem. In an aspect, the solution data 112 can include an optimal solution (e.g., a solution with minimized error) for the decision-making problem (e.g., the mixed-binary constrained optimization problem). In certain embodiments, the quantum processor 104 can generate the solution data 112 in response to a determination that a number of iterations associated with the binary unconstrained optimization process and/or the convex constrained optimization process satisfies a defined criterion. For example, the quantum processor 104 can generate the solution data 112 in response to an instruction that a number of iterations associated with the binary unconstrained optimization process and/or the convex constrained optimization process satisfies a defined criterion. Additionally or alternatively, in certain embodiments, the quantum processor 104 can generate the solution data 112 in response to a determination (e.g., an instruction) that the binary unconstrained optimization process and/or the convex constrained optimization process satisfy a defined criterion. For instance, in certain embodiments, the quantum processor 104 can generate the solution data 112 in response to a determination that the binary unconstrained optimization process and/or the convex constrained optimization process achieve a convergence criterion. Additionally or alternatively, in certain embodiments, the quantum processor 104 can generate the solution data 112 in response to a determination (e.g., an instruction) that first output data and/or the second output data satisfy a defined criterion. For instance, the quantum processor 104 can generate the solution data 112 in response to a determination that first output data and/or the second output data achieve a convergence criterion. In certain embodiments, the solution data 112 can include a quantum state associated with the decision-making problem. In one example, the quantum state can include, for example, a set of quantum bits (e.g., a set of qubits). In another example, the quantum state can include information associated with an x-component measurement, a y-component measurement and/or a z-component measurement associated with a state of a quantum bit associated with the quantum processor 104.

In certain embodiments, the classical processor 106 can perform the convex constrained optimization process based on classifications, correlations, inferences and/or expressions associated with principles of artificial intelligence. In one example, the classical processor 106 can employ a probabilistic and/or statistical-based analysis (e.g., factoring into the analysis utilities and costs) to learn and/or generate inferences with respect to the MBCO data 108 and/or the problem data 110. In an aspect, the classical processor 106 can include an inference component (not shown) that can further enhance aspects of the classical processor 106 utilizing in part inference-based schemes to facilitate learning and/or generating inferences associated with the MBCO data 108 and/or the problem data 110. The classical processor 106 can employ any suitable machine-learning based techniques, statistical-based techniques and/or probabilistic-based techniques. For example, the classical processor 106 can employ expert systems, fuzzy logic, SVMs, Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, etc. In another aspect, the classical processor 106 can perform a set of machine learning computations associated with the MBCO data 108 and/or the problem data 110. For example, the classical processor 106 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations associated with the MBCO data 108 and/or the problem data 110.

It is to be appreciated that the quantum processor 104 and/or the classical processor 106 performs a quantum computing process and/or an optimization process that cannot be performed by a human (e.g., is greater than the capability of a single human mind). For example, an amount of data processed, a speed of data processed and/or data types of data processed by the quantum processor 104 and/or the classical processor 106 over a certain period of time can be greater, faster and different than an amount, a speed and data types that can be processed by a single human mind over the same period of time. The quantum processor 104 and/or the classical processor 106 can also be fully operational towards performing one or more other functions (e.g., fully powered on, fully executed, etc.) while also performing the above-referenced quantum computing process and/or optimization process. Additionally, the quantum processor 104 and/or the classical processor 106 can obtain information that is impossible to obtain manually by a user. For example, a type of information included in the solution data 112, a variety of information included in the solution data 112, and/or an amount of information included in the solution data 112 can be more complex than information obtained manually by a user.

Additionally, it is to be appreciated that the system 100 can provide various advantages as compared to conventional classical computing systems. For instance, a solution for a decision-making problem can be determined by employing the system 100. Furthermore, an amount of time to perform an optimization process can be reduced and/or accuracy of an optimization process can be improved. Moreover, performance a quantum processor can be improved by employing the system 100, efficiency of a quantum processor can be improved by employing the system 100, and/or another characteristic of a quantum processor can be improved by employing the system 100.

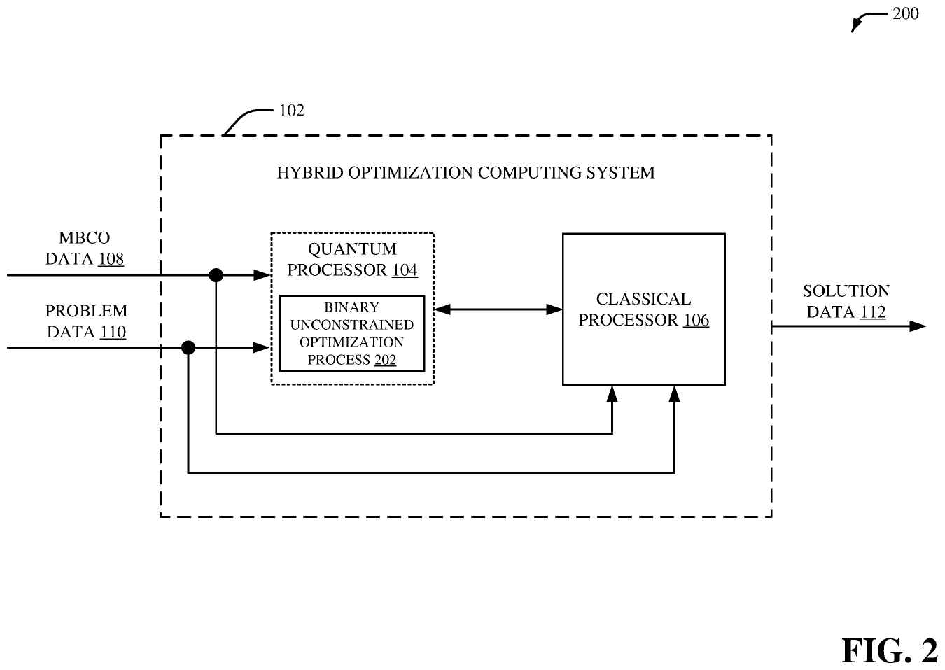

FIG. 2 illustrates a block diagram of an example, non-limiting system 200 in accordance with one or more embodiments described herein. Repetitive description of like elements employed in other embodiments described herein is omitted for sake of brevity.

The system 200 includes the hybrid optimization computing system 102. The hybrid optimization computing system 102 includes the quantum processor 104 and the classical processor 106. In an embodiment shown in FIG. 2, the quantum processor 104 can perform (e.g., execute) a binary unconstrained optimization process 202. The quantum processor 104 can perform the binary unconstrained optimization process 202 based on the MBCO data 108 and/or the problem data 110. For instance, the quantum processor 104 can perform the binary unconstrained optimization process 202 using the MBCO data 108 and/or the problem data 110 to generate at least a portion of the solution data 112. The binary unconstrained optimization process 202 can be a process to solve a binary unconstrained optimization problem associated with the MBCO data 108 and/or the problem data 110. In an aspect, the quantum processor 104 can map the binary unconstrained optimization process 202 onto a set of qubits of the quantum processor 104. The binary unconstrained optimization process 202 can process binary variables associated with the MBCO data 108 and/or the problem data 110. Additionally or alternatively, the binary unconstrained optimization process 202 can process unconstrained variables associated with the MBCO data 108 and/or the problem data 110. A binary variable associated with the MBCO data 108 and/or the problem data 110 can be a variable with either a first value or a second value. An unconstrained variable associated with the MBCO data 108 and/or the problem data 110 can be a variable with any value. For example, an unconstrained variable associated with the MBCO data 108 and/or the problem data 110 can be a continuous variable with an infinite number of possible values. In another aspect, the binary unconstrained optimization process 202 can be associated with a complexity class. For instance, the complexity class for the binary unconstrained optimization process 202 can be NP complexity class associated with an execution time for processing the MBCO data 108 and/or the problem data 110 that is bounded by a polynomial expression. In certain embodiments, the binary unconstrained optimization process 202 can be performed based on a variational quantum eigensolver. For example, the binary unconstrained optimization process 202 can be mapped to a quantum-variational eigensolver architecture of the quantum processor 104. In another, the binary unconstrained optimization process 202 can be performed based on phase estimation.

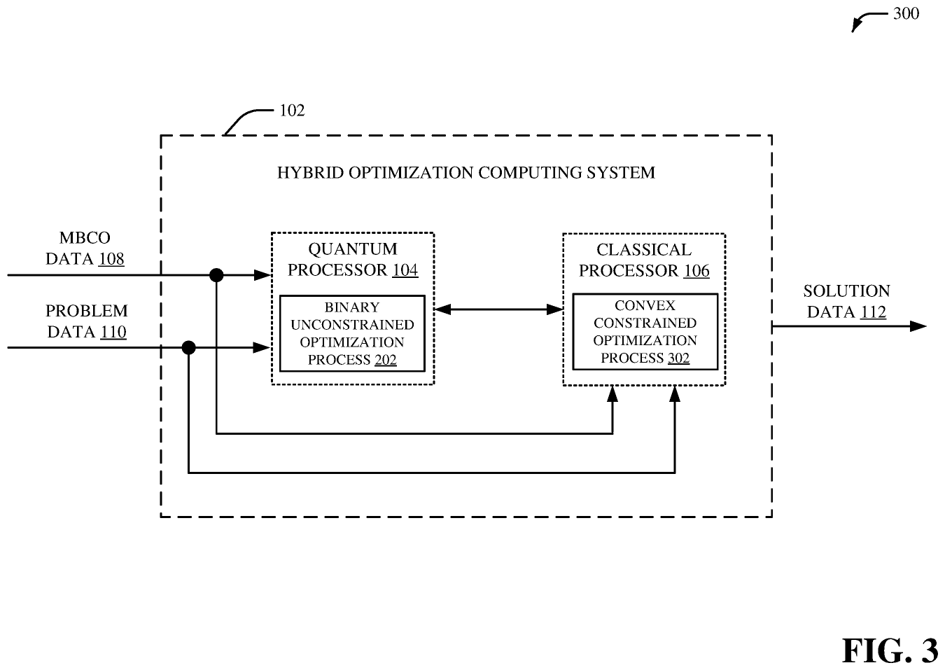

FIG. 3 illustrates a block diagram of an example, non-limiting system 300 in accordance with one or more embodiments described herein. Repetitive description of like elements employed in other embodiments described herein is omitted for sake of brevity.

The system 300 includes the hybrid optimization computing system 102. The hybrid optimization computing system 102 includes the quantum processor 104 and the classical processor 106. In an embodiment shown in FIG. 3, the quantum processor 104 can perform (e.g., execute) the binary unconstrained optimization process 202. Additionally, the classical processor 106 can perform (e.g., execute) a convex constrained optimization process 302. The classical processor 106 can perform the convex constrained optimization process 302 based on the MBCO data 108 and/or the problem data 110. For instance, the classical processor 106 can perform the convex constrained optimization process 302 based on the MBCO data 108 and/or the problem data 110 to provide input data for the binary unconstrained optimization process 202. In an example, the classical processor 106 can perform the convex constrained optimization process 302 based on the MBCO data 108 and/or the problem data 110 to update and/or modify one or more portions of the binary unconstrained optimization process 202. Additionally or alternatively, the classical processor 106 can perform the convex constrained optimization process 302 based on the MBCO data 108 and/or the problem data 110 to generate at least a portion of the solution data 112. The convex constrained optimization process 302 can be a process to solve a convex constrained optimization subproblem associated with the MBCO data 108 and/or the problem data 110. The convex constrained optimization process 302 can process constrained variables associated with the MBCO data 108 and/or the problem data 110. A value of the constrained variables can also be bounded by a convex function. As such, a constrained variable associated with the MBCO data 108 and/or the problem data 110 can be a variable with a bounded value. In an aspect, the convex constrained optimization process 302 can be employed to minimize cost and/or energy associated with the binary unconstrained optimization process 202. For instance, the convex constrained optimization process 302 can generate a loss function for the binary unconstrained optimization process 202. The loss function can, for example, modify one or more portions of the binary unconstrained optimization process 202 and/or one or more settings for the quantum processor 104. In certain embodiments, one or more iterations of the binary unconstrained optimization process 202 can be repeated in parallel to the convex constrained optimization process 302.

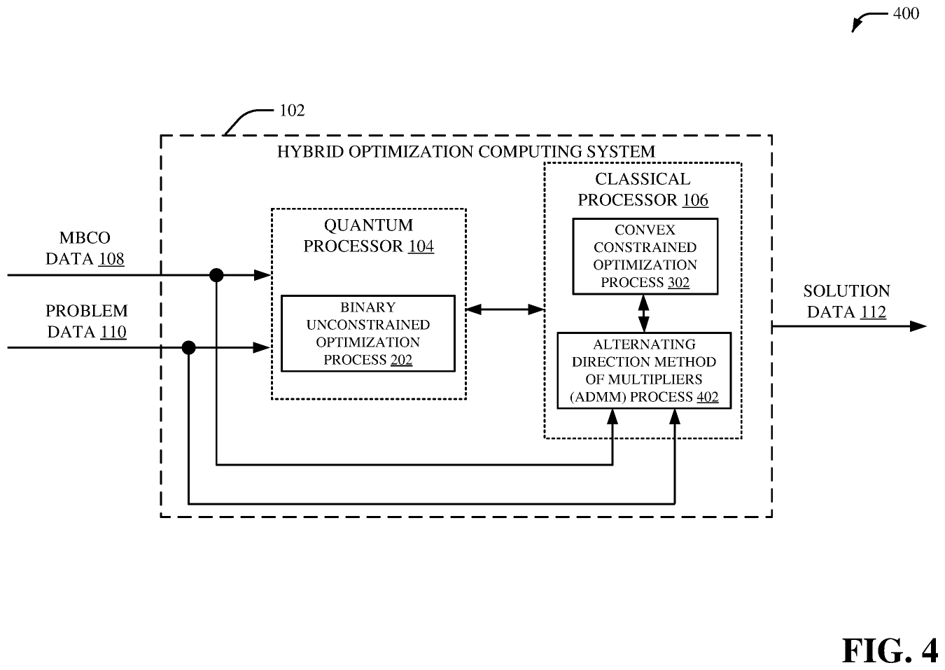

FIG. 4 illustrates a block diagram of an example, non-limiting system 400 in accordance with one or more embodiments described herein. Repetitive description of like elements employed in other embodiments described herein is omitted for sake of brevity.

The system 400 includes the hybrid optimization computing system 102. The hybrid optimization computing system 102 includes the quantum processor 104 and the classical processor 106. In an embodiment shown in FIG. 4, the quantum processor 104 can perform (e.g., execute) the binary unconstrained optimization process 202. Additionally, the classical processor 106 can perform (e.g., execute) the convex constrained optimization process 302 and/or an alternating direction method of multipliers (ADMM) process 402. The ADMM process 402 can split data for processing by the binary unconstrained optimization process 202 and the convex constrained optimization process 302. For example, the ADMM process 402 can split data for processing by the binary unconstrained optimization process 202 and the convex constrained optimization process 302 to facilitate convex optimization of the MBCO data 108 and/or the problem data 110. The ADMM process 402 can employ a penalty term by replacing constrained optimization problem of the convex constrained optimization process 302 with one or more unconstrained processes. In an embodiment, the ADMM process 402 can determine a portion of the MBCO data 108 and/or the problem data 110 for processing by the quantum processor 104 and another portion of the MBCO data 108 and/or the problem data 110 for processing by the classical processor 106. For example, the ADMM process 402 can determine a first portion of the MBCO data 108 and/or the problem data 110 for processing by the binary unconstrained optimization process 202. Furthermore, the ADMM process 402 can determine a second portion of the MBCO data 108 and/or the problem data 110 for processing by the convex constrained optimization process 302. As such, the ADMM process 402 can be employed for routing data for the binary unconstrained optimization process 202 and the convex constrained optimization process 302. In an embodiment, the ADMM process 402 can be applied to mixed-binary linear programming associated with the binary unconstrained optimization process 202 and/or the convex constrained optimization process 302. In another embodiment, the ADMM process 402 can determine a portion of the MBCO data 108 and/or the problem data 110 for processing by a variational quantum eigensolver of the quantum processor 104. For instance, the ADMM process 402 can determine a portion of the MBCO data 108 and/or the problem data 110 for processing by a variational quantum eigensolver of the quantum processor 104 in response to a determination that an Ising Hamiltonian model associated with the MBCO data 108 and/or the problem data 110 is formulated by the quantum processor 104. In another, the ADMM process 402 can determine a portion of the MBCO data 108 and/or the problem data 110 for processing by a quantum phase estimation algorithm.

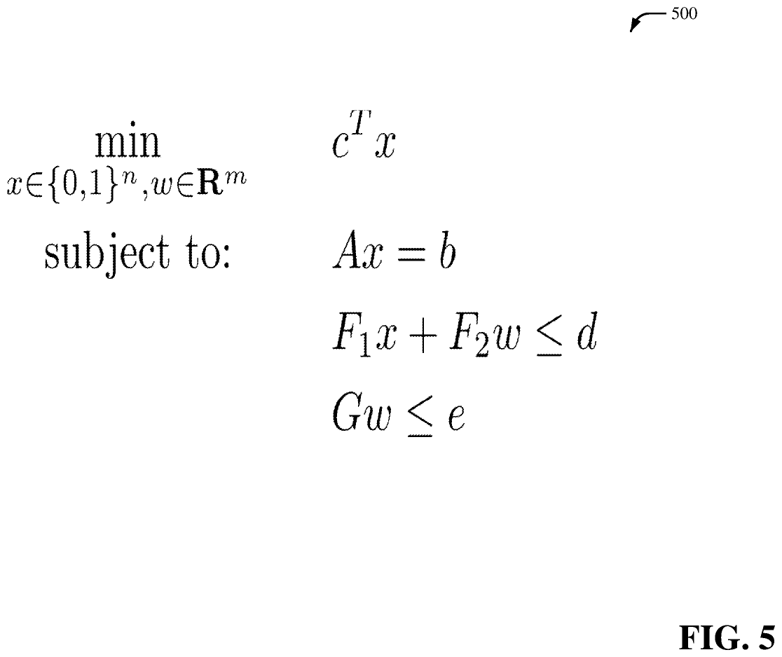

FIG. 5 illustrates a block diagram of an example, non-limiting formulation 500 in accordance with one or more embodiments described herein. Repetitive description of like elements employed in other embodiments described herein is omitted for sake of brevity.

The formulation 500 can represent a decision-making problem. For instance, the formulation 500 can represent a mixed-binary constrained optimization problem. In an example, the formulation 500 can be a mathematical formulation associated with mixed-binary linear programming The formulation 500 can include discrete variables x and continuous variables w. The formulation 500 can also include a vector c, a matrix A, a vector b, a matrix F₁, a matrix F₂, a vector d, a matrix G, and a vector e. The discrete variables x and the continuous variables w can be subject to equality constraints and inequality constraints. In an embodiment, the formulation 500 can represent, for example, the MBCO data 108. Furthermore, the vector c, the matrix A, the vector b, the matrix F₁, the matrix F₂, the vector d, the matrix G, and the vector e can represent problem data 110, for example. For instance, the vector c, the matrix A, the vector b, the matrix F₁, the matrix F₂, the vector d, the matrix G, and the vector e can represent a set of parameters for the formulation 500. In certain embodiments, the problem data 110 can additionally include a time window for the parameters.

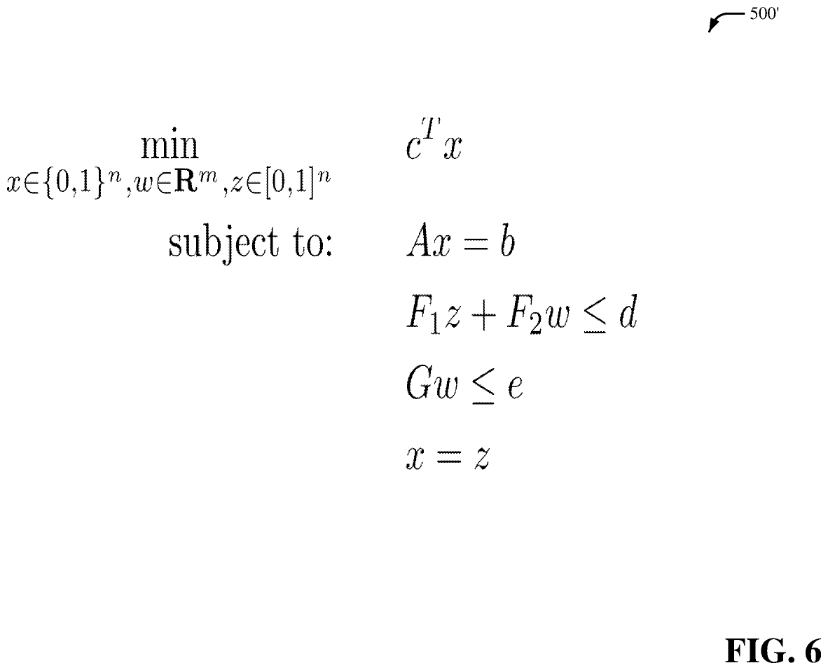

FIG. 6 illustrates a block diagram of an example, non-limiting formulation 500′ in accordance with one or more embodiments described herein. Repetitive description of like elements employed in other embodiments described herein is omitted for sake of brevity.

The formulation 500′ can represent a modified version of the formulation 500. For example, the formulation 500′ can represent a modified version of the decision-making problem. In an aspect, the formulation 500 can be split into a binary component of the decision-making problem and a continuous component of the of the decision-making problem to provide the formulation 500′. For example, discrete variables z can be added. As such, the discrete variables x can represent a binary component associated with a binary unconstrained optimization process (e.g., the binary unconstrained optimization process 202) Furthermore, the discrete variables z can represent a binary component associated with a convex constrained optimization process (e.g., the convex constrained optimization process 302) and the continuous variables w can represent a continuous component associated with a convex constrained optimization process (e.g., the convex constrained optimization process 302).

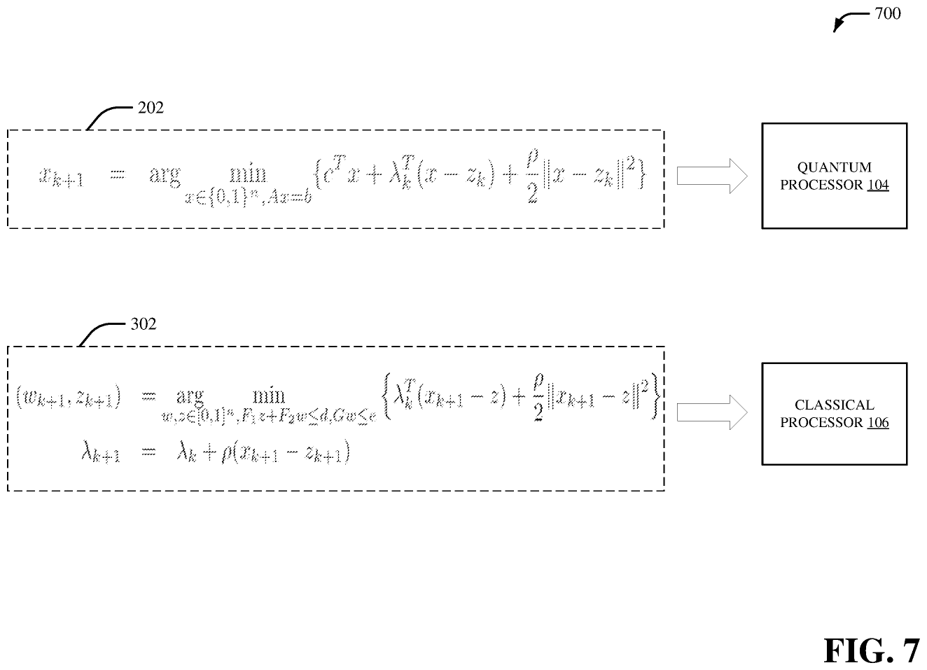

FIG. 7 illustrates a block diagram of an example, non-limiting system 700 in accordance with one or more embodiments described herein. Repetitive description of like elements employed in other embodiments described herein is omitted for sake of brevity.

The system 700 includes a non-limiting example of the binary unconstrained optimization process 202 and a non-limiting example of the convex constrained optimization process 302. In an example, the binary unconstrained optimization process 202 and the convex constrained optimization process 302 can be formed in response to application of an ADMM process (e.g., the ADMM process 402) to the formulation 501′. The binary unconstrained optimization process 202 can be an iterative process indexed by k where parameter λ is a multiplier parameter and parameter ρ is a positive scalar parameter. The convex constrained optimization process 302 can be a different iterative process indexed by k where parameter is a multiplier parameter and parameter ρ is a positive scalar parameter. The binary unconstrained optimization process 202 can be executed by the quantum processor 104. For example, the binary unconstrained optimization process 202 can be mapped to a set of qubits of the quantum processor 104. In an aspect, the binary unconstrained optimization process 202 can iteratively determine a value of the discrete variables x. The convex constrained optimization process 302 can be executed by the classical processor 106. In an aspect, the convex constrained optimization process 302 can iteratively determine a value of the continuous variables w. Additionally or alternatively, the convex constrained optimization process 302 can iteratively determine a value of the discrete variables z. Additionally or alternatively, the convex constrained optimization process 302 can iteratively determine a value of the multiplier parameter λ. In certain embodiments, the binary unconstrained optimization process 202 can be modified and/or updated based on a value of the multiplier parameter λ determined by the convex constrained optimization process 302. In certain embodiments, the binary unconstrained optimization process 202 can be solved using a variational quantum eigensolver of the quantum processor 104. In certain embodiments, the binary unconstrained optimization process 202 can be solved using phase estimation (e.g., a quantum phase estimation algorithm) associated with the quantum processor 104. In an aspect, the binary unconstrained optimization process 202 and the convex constrained optimization process 302 can be iteratively performed to generate solution data (e.g., the solution data 112) for the decision-making problem associated with the formulation 500.

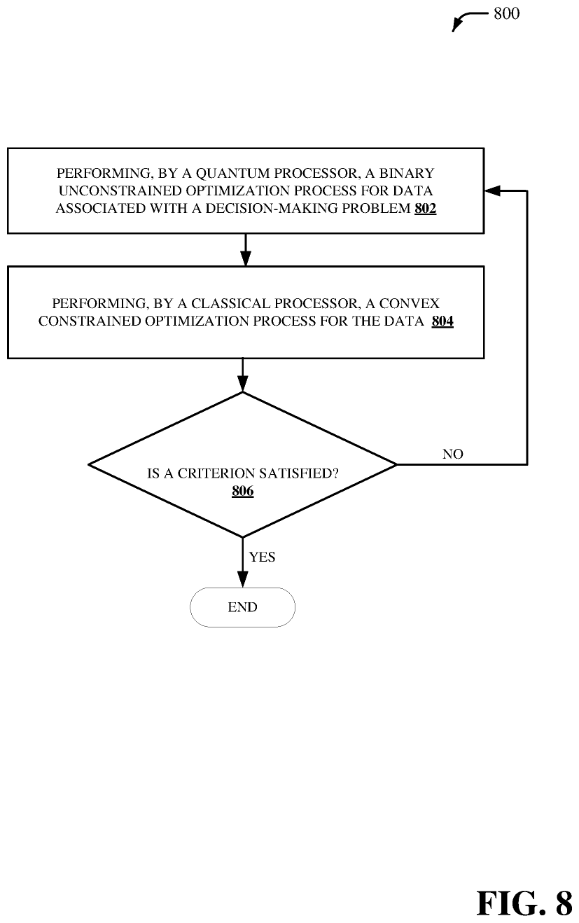

FIG. 8 illustrates a flow diagram of an example, non-limiting method 800 for facilitating mixed-binary constrained optimization on quantum computers in accordance with one or more embodiments described herein. At 802, a binary unconstrained optimization process for data associated with a decision-making problem is performed by a quantum processor (e.g., by quantum processor 104). The data can include mixed-binary constrained optimization data and/or problem data. In an aspect, the mixed-binary constrained optimization data and/or the problem data can be associated with the decision-making problem. In one example, the mixed-binary constrained optimization data and/or the problem data can be associated with a mixed-binary constrained optimization problem. In an embodiment, the mixed-binary constrained optimization data can be a mixed-binary constrained optimization formulation that expresses a relationship and/or a structure for a real-world application. The problem data can include one or more variables for the mixed-binary constrained optimization data. For example, the problem data can include one or more vectors of data and/or one or more data matrices that are applied to the mixed-binary constrained optimization data. The binary unconstrained optimization process can be a process to solve a binary unconstrained optimization problem associated with the mixed-binary constrained optimization data and/or the problem data. In an aspect, the quantum processor can map the binary unconstrained optimization process onto a set of qubits of the quantum processor. The binary unconstrained optimization process can process binary variables and/or unconstrained variables. A binary variable can be a variable with either a first value or a second value. An unconstrained variable can be a variable with any value. For example, an unconstrained variable can be a continuous variable with an infinite number of possible values. In another aspect, the binary unconstrained optimization process performed by the quantum processor can be associated with a complexity class. For instance, the complexity class for the binary unconstrained optimization process can be NP complexity class associated with an execution time for the decision-making problem that is bounded by a polynomial expression. In certain embodiments, the quantum processor can perform the binary unconstrained optimization process based on a variational quantum eigensolver. For example, the binary unconstrained optimization process can be mapped to a quantum-variational eigensolver architecture of the quantum processor. In certain embodiments, the quantum processor can perform the binary unconstrained optimization process based on phase estimation.

At 804, a convex constrained optimization process for the data is performed by a classical processor (e.g., by classical processor 106). The convex constrained optimization process can be a process to solve a convex constrained optimization subproblem associated with the mixed-binary constrained optimization data and/or the problem data. The convex constrained optimization process can process constrained variables associated with a convex function. A constrained variable can be a variable with a bounded value. In an aspect, the convex constrained optimization process can be employed to minimize cost and/or energy associated with the binary unconstrained optimization process. For instance, the convex constrained optimization process can generate a loss function (e.g., a multiplier) to modify one or more portions of the binary unconstrained optimization process and/or to modify one or more settings for the quantum processor.

At 806, it is determined whether a criterion is satisfied. For example, it can be determined wither a certain number of iterations associated with the binary unconstrained optimization process and/or the convex constrained optimization process are performed. In another example, it can be determined whether a convergence criterion for the decision-making problem is achieved. If no, the method 800 returns to 802. If yes, the method 800 ends.

In certain embodiments, the performing the binary unconstrained optimization process and/or the performing the convex constrained optimization includes performing the binary unconstrained optimization process and/or the performing the convex constrained optimization to solve a mixed-binary constrained optimization problem. In certain embodiments, the method 800 can additionally or alternatively include generating, by the quantum processor 104 and/or the classical processor 106, solution data associated with the decision-making problem based on first output data associated with the binary unconstrained optimization process and second output data associated with the binary unconstrained optimization process. In certain embodiments, the method 800 can additionally or alternatively include generating the solution data in response to a determination that a number of iterations associated with the binary unconstrained optimization process and the convex constrained optimization process satisfies a defined criterion. In certain embodiments, the method 800 can additionally or alternatively include generating the solution data in response to a determination that the first output data and the second output data satisfy a defined criterion. In certain embodiments, the performing the binary unconstrained optimization process and/or the performing the convex constrained optimization includes providing improved performance for the quantum processor.

For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that, in certain embodiments, at least a portion of the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device or storage media.

Moreover, because at performing a binary unconstrained optimization process using a quantum processor, performing a convex constrained optimization problem using a classical processor, etc. are established from a combination of electrical and mechanical components and circuitry, a human is unable to replicate or perform processing performed by the quantum processor 104 and/or the classical processor 106 disclosed herein. For example, a human is unable to perform a quantum computing process, a quantum optimization process, a hybrid optimization computing process, etc.

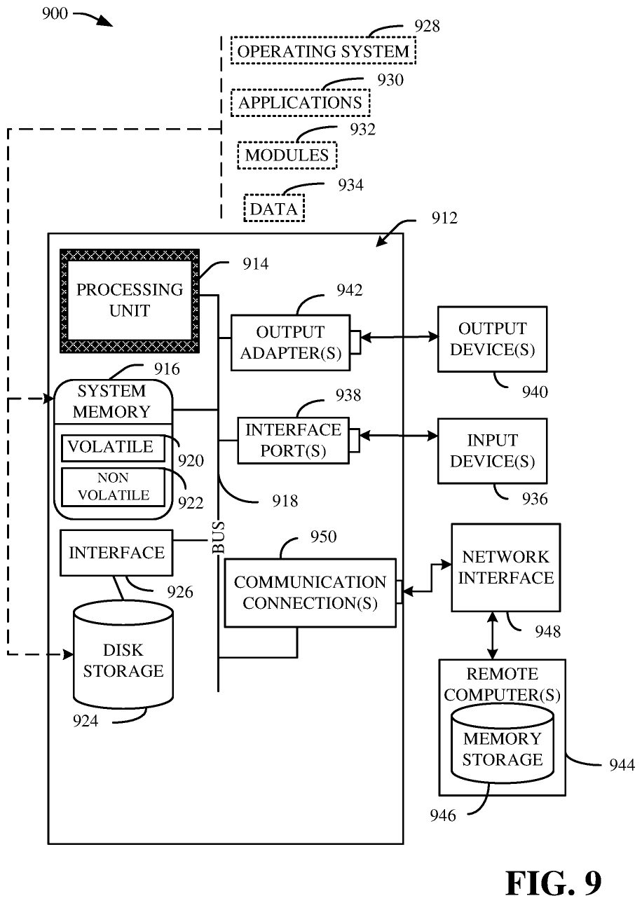

In order to provide a context for the various aspects of the disclosed subject matter, FIG. 9 as well as the following discussion are intended to provide a general description of a suitable environment in which the various aspects of the disclosed subject matter can be implemented. FIG. 9 illustrates a block diagram of an example, non-limiting operating environment in which one or more embodiments described herein can be facilitated. Repetitive description of like elements employed in other embodiments described herein is omitted for sake of brevity.

With reference to FIG. 9, a suitable operating environment 900 for implementing various aspects of this disclosure can also include a computer 912. The computer 912 can also include a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914. The system bus 918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 916 can also include volatile memory 920 and nonvolatile memory 922. The basic input/output system (BIOS), containing the basic routines to transfer information between elements within the computer 912, such as during start-up, is stored in nonvolatile memory 922. Computer 912 can also include removable/non-removable, volatile/non-volatile computer storage media. FIG. 9 illustrates, for example, a disk storage 924. Disk storage 924 can also include, but is not limited to, devices like a magnetic disk drive, floppy disk drive, tape drive, Jaz drive, Zip drive, LS-100 drive, flash memory card, or memory stick. The disk storage 924 also can include storage media separately or in combination with other storage media. To facilitate connection of the disk storage 924 to the system bus 918, a removable or non-removable interface is typically used, such as interface 926. FIG. 9 also depicts software that acts as an intermediary between users and the basic computer resources described in the suitable operating environment 900. Such software can also include, for example, an operating system 928. Operating system 928, which can be stored on disk storage 924, acts to control and allocate resources of the computer 912.

System applications 930 take advantage of the management of resources by operating system 928 through program modules 932 and program data 934, e.g., stored either in system memory 916 or on disk storage 924. It is to be appreciated that this disclosure can be implemented with various operating systems or combinations of operating systems. A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port can be used to provide input to computer 912, and to output information from computer 912 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a computer, a server, a router, a network PC, a workstation, a microprocessor based appliance, a peer device or other common network node and the like, and typically can also include many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 950 refers to the hardware/software employed to connect the network interface 948 to the system bus 918. While communication connection 950 is shown for illustrative clarity inside computer 912, it can also be external to computer 912. The hardware/software for connection to the network interface 948 can also include, for exemplary purposes only, internal and external technologies such as, modems including regular telephone grade modems, cable modems and DSL modems, ISDN adapters, and Ethernet cards.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

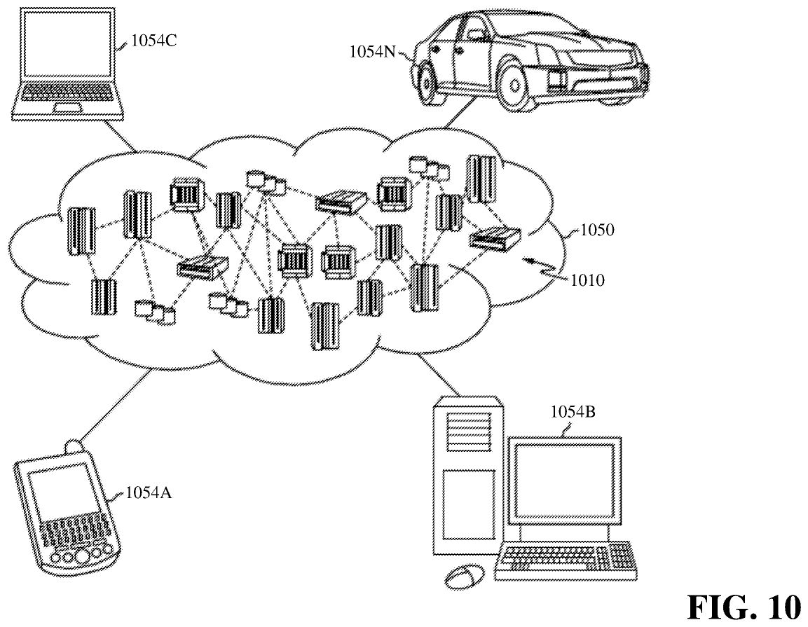

Referring now to FIG. 10, an illustrative cloud computing environment 1050 is depicted. As shown, cloud computing environment 1050 includes one or more cloud computing nodes 1010 with which local computing devices used by cloud consumers, such as, for example, personal digital assistant (PDA) or cellular telephone 1054A, desktop computer 1054B, laptop computer 1054C, or automobile computer system 1054N may communicate. Nodes 1010 may communicate with one another. They may be grouped (not shown) physically or virtually, in one or more networks, such as Private, Community, Public, or Hybrid clouds as described hereinabove, or a combination thereof. This allows cloud computing environment 1050 to offer infrastructure, platforms or software as services for which a cloud consumer does not need to maintain resources on a local computing device. It is understood that the types of computing devices 1054A-N shown in FIG. 10 are intended to be illustrative only and that computing nodes 1010 and cloud computing environment 1050 can communicate with any type of computerized device over any type of network or network addressable connection (e.g., using a web browser).

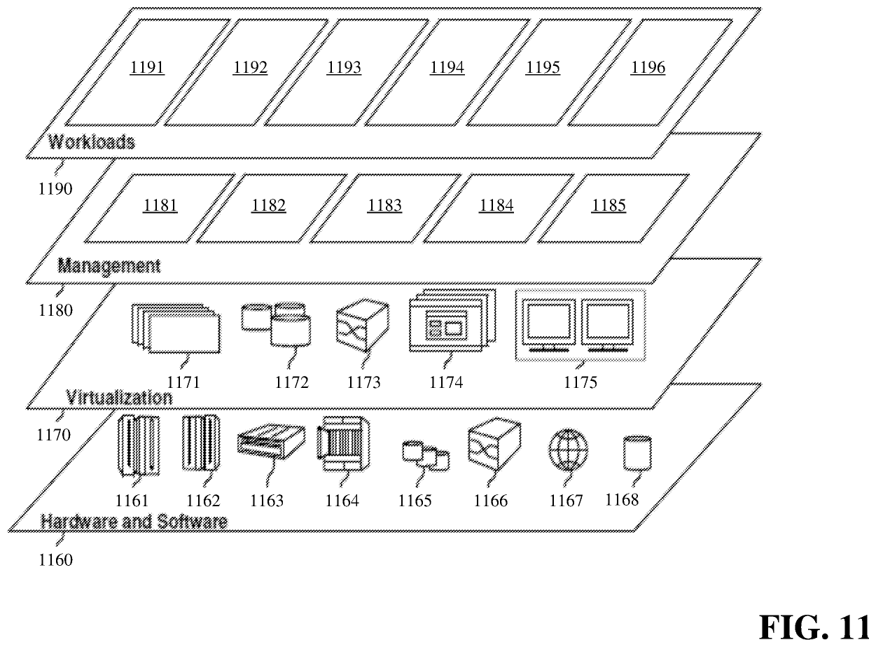

Referring now to FIG. 11, a set of functional abstraction layers provided by cloud computing environment 1050 (FIG. 10) is shown. It should be understood in advance that the components, layers, and functions shown in FIG. 11 are intended to be illustrative only and embodiments of the invention are not limited thereto. As depicted, the following layers and corresponding functions are provided:

Hardware and software layer 1160 includes hardware and software components. Examples of hardware components include: mainframes 1161; RISC (Reduced Instruction Set Computer) architecture based servers 1162; servers 1163; blade servers 1164; storage devices 1165; and networks and networking components 1166. In some embodiments, software components include network application server software 1167 and database software 1168.

Virtualization layer 1170 provides an abstraction layer from which the following examples of virtual entities may be provided: virtual servers 1171; virtual storage 1172; virtual networks 1173, including virtual private networks; virtual applications and operating systems 1174; and virtual clients 1175.

In one example, management layer 1180 may provide the functions described below. Resource provisioning 1181 provides dynamic procurement of computing resources and other resources that are utilized to perform tasks within the cloud computing environment. Metering and Pricing 1182 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1183 provides access to the cloud computing environment for consumers and system administrators. Service level management 1184 provides cloud computing resource allocation and management such that required service levels are met. Service Level Agreement (SLA) planning and fulfillment 1185 provide pre-arrangement for, and procurement of, cloud computing resources for which a future requirement is anticipated in accordance with an SLA.

Workloads layer 1190 provides examples of functionality for which the cloud computing environment may be utilized. Non-limiting examples of workloads and functions which may be provided from this layer include: mapping and navigation 1191; software development and lifecycle management 1192; virtual classroom education delivery 1193; data analytics processing 1194; transaction processing 1195; and mixed-binary constrained optimization software 1196.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a quantum processor that performs a binary unconstrained optimization process for data associated with a decision-making problem; and
a classical processor that performs a convex constrained optimization process for the data.

2. The system of claim 1, wherein the data is associated with a mixed-binary constrained optimization problem.

3. The system of claim 1, wherein the quantum processor performs the binary unconstrained optimization process based on a variational quantum eigensolver.

4. The system of claim 1, wherein the quantum processor performs the binary unconstrained optimization process based on phase estimation.

5. The system of claim 1, wherein the classical processor provides first output data associated with the convex constrained optimization process to the quantum processor, and wherein the quantum processor generates solution data associated with the decision-making problem based on the first output data and second output data generated by the binary unconstrained optimization process.

6. The system of claim 5, wherein the quantum processor generates the solution data in response to a determination that a number of iterations associated with the binary unconstrained optimization process and the convex constrained optimization process satisfies a defined criterion.

7. The system of claim 5, wherein the quantum processor generates the solution data in response to a determination that the first output data and the second output data satisfy a defined criterion.

8. The system of claim 1, wherein the classical processor employs an alternating direction method of multipliers process to split the decision-making problem for processing by the binary unconstrained optimization process and the convex constrained optimization process.

9. The system of claim 1, wherein the quantum processor performs the binary unconstrained optimization process and the classical processor performs the convex constrained optimization process to provide improved performance for the quantum processor.

10. A method, comprising:
performing, by a quantum processor, a binary unconstrained optimization process for data associated with a decision-making problem; and
performing, by a classical processor, a convex constrained optimization process for the data.

11. The method of claim 10, wherein the performing the binary unconstrained optimization process comprises performing the binary unconstrained optimization process based on a variational quantum eigensolver or phase estimation.

12. The method of claim 10, wherein the performing the binary unconstrained optimization process comprises performing the binary unconstrained optimization process to solve a mixed-binary constrained optimization problem.

13. The method of claim 10, further comprising:
generating, by the quantum processor, solution data associated with the decision-making problem based on first output data associated with the binary unconstrained optimization process and second output data associated with the binary unconstrained optimization process.

14. The method of claim 13, wherein the generating the solution data comprises generating the solution data in response to a determination that a number of iterations associated with the binary unconstrained optimization process and the convex constrained optimization process satisfies a defined criterion.

15. The method of claim 13, wherein the generating the solution data comprises generating the solution data in response to a determination that the first output data and the second output data satisfy a defined criterion.

16. The method of claim 10, wherein the performing the convex constrained optimization process comprises providing improved performance for the quantum processor.

17. A system, comprising:
a quantum processor that performs a binary unconstrained optimization process for data associated with a decision-making problem; and
a classical processor that performs a convex constrained optimization process for the data, wherein the quantum processor generates solution data associated with the decision-making problem based on the binary unconstrained optimization process and the convex constrained optimization process.

18. The system of claim 17, wherein the quantum processor generates the solution data based on an alternating direction method of multipliers process.

19. The system of claim 17, wherein the quantum processor generates the solution data for a mixed-binary constrained optimization problem.

20. The system of claim 17, wherein the quantum processor performs the binary unconstrained optimization process based on a variational quantum eigensolver or a quantum phase estimation algorithm.
